(19) United States
(12) Patent Application Publication
(10) Pub. No.: US 2016/0363452 A1
(43) Pub. Date: Dec. 15, 2016

(54) SYSTEM AND METHOD TO PROVIDE A USER AN INFORMATIONAL TOUR

(71) Applicant: 6Planes, LLC, Houston, TX (US)

(72) Inventors: Timothy Mehlman, Houston, TX (US); Hien Le, Houston, TX (US)

(73) Assignee: 6Planes, LLC, Houston, TX (US)

(21) Appl. No.: 15/177,550

(22) Filed: Jun. 9, 2016

Related U.S. Application Data
(60) Provisional application No. 62/173,198, filed on Jun. 9, 2015.

(51) Int. Cl. G01C 21/20; G01C 21/36; H04L 29/08; H04W 4/04; G06F 17/30; H04W 4/00; G01C 21/34; G06Q 50/16

(52) U.S. Cl. CPC G01C 21/206; G01C 21/3407; G01C 21/3679; G06Q 50/16; H04W 4/043; G06F 17/30241; H04W 4/008; H04L 67/06

(57) ABSTRACT

A method to provide a user an informational tour of a location includes emitting a position signal from a wireless device at a position along the informational tour, detecting the position signal with an electronic device, and outputting information based upon the position signal with the electronic device.

### BACKGROUND INFORMATION

This section is intended to introduce the reader to various aspects of art that may be related to various aspects of the presently described embodiments. This discussion is believed to be helpful in providing the reader with background information to facilitate a better understanding of the various aspects of the described embodiments. Accordingly, it should be understood that these statements are to be read in this light and not as admissions of prior art.

Real estate properties may span large spaces and/or may contain one or more items or locations of interest that are showcased for sale or to influence the buying or renting decision relating to the real estate. A customer, visitor, employee, or user oftentimes may require an in-person tour or explanation of the real estate property, physical layout, and contents of the property. While the tour is often beneficial, and potentially even necessary, to showcasing the real estate, the tour can be a burden on the resources managing the real estate (e.g., physical or human resources), particularly as the number of tours increase. Traditional in-person tours can also have issues, such as with consistency, convenience, communication, analytics, and potentially in other areas, given the difficulties to setup and conduct in person real estate tours.

### BRIEF DESCRIPTION OF DRAWINGS

For a detailed description of the embodiments of the invention, reference will now be made to the accompanying drawings in which:

FIG. 1 shows a top down view of a tour system within a multi-family property in accordance with one or more embodiments of the present disclosure;

FIG. 2 shows a top down view of a tour system within a model unit in accordance with one or more embodiments of the present disclosure;

FIG. 3 shows a top down view of a tour system within a leasing center in accordance with one or more embodiments of the present disclosure;

FIG. 4 shows a top down view of a tour system within a single family home in accordance with one or more embodiments of the present disclosure;

FIG. 5 shows a top down view of a tour system within a retail center in accordance with one or more embodiments of the present disclosure;

FIG. 6 shows a top down view of a tour system within a retail store in accordance with one or more embodiments of the present disclosure;

FIGS. 7A and 7B show views of a wayfinding overlay in accordance with one or more embodiments of the present disclosure;

FIGS. 8A and 8B show views of a wireless device cover in accordance with one or more embodiments of the present disclosure;

FIGS. 9-12 show views of user interface of a tour application in accordance with one or more embodiments of the present disclosure; and

FIGS. 13-16 show views of dashboard of a computing device in accordance with one or more embodiments of the present disclosure.

### DETAILED DESCRIPTION

The present disclosure may relate to a system of providing a customer, visitor, employee, or another user (referred to herein as a “user”) an informational or marketing tour (referred to herein as a “tour”) independent of a human guide or salesperson (though the system may also supplement an in-person tour). The system may include one or more of the following:
a tablet or other electronic device including a display screen (referred to as a “display device”) with the capability to receive a combination of tracking, positioning, and/or event triggering related information from a wireless transmission (e.g., low-energy Bluetooth transmission or a similar signal protocol). Such a display device may be owned by the user or a third-party, such as, but not limited to, the owner of the real estate area or business owner of the business the user is touring;
another electronic device containing a display screen remote from the display device (referred to herein as an “additional display screen”);
none, one, or more physical objects placed along the intended path of travel for the tour with the intent to enhance the user experience or display for sale or rent;
one or more devices that transmit information using a wireless transmission (e.g., low-energy Bluetooth transmission or a similar signal protocol) (referred to as a “wireless device”) that will be set on an intended path of travel or establishing a field for the user to travel through for the tour;
none, one, or more wireless device covers to visually reinforce the intended path of the user. Such a wireless device cover (e.g., a radio frequency (“RF”) shield) may contain internal shielding to direct and/or calibrate the power and/or direction of the signal of the wireless device;
none, one, or more computing devices (referred to as a “computing device”) that may communicate with the user or administrators prior to, during, or following the tour to provide information related to or ancillary to the tour, such as through the display device or additional display screen;
an application program (referred to as a “tour application”) that is programmed and loaded onto or interacted with by the display device to coordinate the tour and coordinate the distribution of information related to or ancillary to the tour. The tour application may communicate information to and receive information from an ancillary application; and
an application program (referred to as an “ancillary application”) that is loaded onto or interacted with by the computing device to coordinate the distribution of information related to or ancillary to the tour. The ancillary application may communicate information to and receive information from the tour application.

In one or more embodiments, the display device and/or the additional display screen is programmed or set to provide information related to or ancillary to the tour upon the system recognizing the user has arrived at an intended location utilizing one or more wireless devices.

In one or more embodiments, the physical object may be placed along the intended path of travel, in which the display device or additional display screen may be used to call the attention of the user to the physical object near or at the moment the system recognizes the user is in the proximate location of the physical object or after the user has seen the physical object.

In one or more embodiments, the computing device, display device, and/or additional display screen utilizing the tour application or the ancillary application may communicate with the user prior to, during, and/or following the tour. When communicating with the user, the computing device, display device, and/or additional display screen to provide information related to or ancillary to the tour reminding the user of the subject and contents of the tour, supporting information providing the user additional information relating to the subject and contents of the tour, or marketing material and related discounts or benefits to the user relating to the subject and contents of the tour. Such information or interactions (referred to as “tour information” or “ancillary information”) may include, but is not limited to: video information, picture information, textual information, audio information or music, interactive information obtained through wireless communication (e.g., media from the internet), sales information, and/or navigation information. Tour information may be conveyed in different languages or in different formats for hearing and/or visual impairments. The tour application may also allow a user to communicate with knowledgeable individuals (e.g., property staff members) in real-time while using or through the tour application, such as through the form of a live video or audio feed.

In one or more embodiments, the computing device, display device, and/or additional display screen utilizing the tour application or the ancillary application may track the specific tour path of the user and algorithmically determine how best to provide follow-up information to that user based on this tour path data. The computing device, display device, and/or additional display screen utilizing the tour application or the ancillary application may communicate with the user prior to, during, and/or following the tour to provide ancillary information, which may include providing indirect marketing material and related discounts or benefits to the user that are deemed relevant to the user given the nature of the tour, or may include providing supporting, additional information, or marketing material pertaining to sales and services of potential interest to the user given the nature of the tour.

The present disclosure may relate to a method of providing a tour utilizing the system described in one or more of the above paragraphs (referred to as a “tour system”) to be utilized for a tour of a multi-family or multi-unit condominium property. The tour will allow a prospective multi-family or multi-unit condominium property tenant or buyer, multi-family or multi-unit condominium property employee, or other person interested in touring a multi-family or multi-unit condominium property (referred to as a “prospect”) to tour the property independent of a multi-family or condominium salesperson or supplement a tour with a multi-family or condominium salesperson. The tour system may show the prospect tour information, such as, but not limited to, information specific to the multi-family or multi-unit condominium property including common area and interior unit features, pictures of views from each unit, information relating to amenities on-site and off-site of the subject multi-family property, and promotions related to leasing or purchase at the property. The tour application or ancillary application may be programmed to query the prospect on preferences, such as, but not limited to, music preference, color preference, apartment configuration preference, and areas of the multi-family property the prospect would and would not like included on the tour. The tour application thereafter may be able to direct the prospect to a tour customized with the preferences of the prospect, such as, but not limited to directing the prospect to only the desired destinations on the tour, which may include only the preferred multi-family or multi-unit condominium unit size and configuration, in which the preferred music of the prospect may be played in an external audio device or the display device. The display device or additional display screen may allow the prospect to apply and sign a lease with the property or offer to purchase a unit at the property. Ancillary information deemed of interest to a prospect in the process of moving could be sent to the prospect before, during, and after a tour, such as, but not limited to, information regarding moving services, cleaning services, furniture, home repair or renovation services, electronic devices utilized in the home, proximate restaurants, and proximate convenience services (e.g., dry cleaning, hair stylist, etc.). Given the eCommerce method of communication via the display device operating the tour application or the computing device operating the ancillary application before, during, or after the tour, one or more physical objects, such as, but not limited to, furniture, fixtures, electronics, and equipment may be displayed at regular or subsidized pricing to the multi-family or multi-unit condominium property owner given the opportunity of the owner of the physical objects to market those physical objects for sale to prospects and users of the tour.

The present disclosure may relate to a method of providing a tour utilizing the tour system for a single-family or condominium property. The tour will allow a prospect, such as a prospective single-family property or condominium property buyer or tenant or any other person interested in touring a single-family or condominium, to tour the property independent of a salesperson or supplement the tour with a salesperson. It is common that the salesperson representing a seller (referred to as a “seller's agent”) who is more knowledgeable about a single-family or condominium property to not be available or present at a tour, in which case only the real estate agent representing the buyer would be present. The tour system will allow the seller's agent to record and customize tour information pertaining to the single-family or condominium property. The tour system may show the prospect tour information, such as, but not limited to, information specific to the single-family property or condominium property including common area amenities and interior home features, information relating to amenities on-site and off-site of the subject single-family property or condominium property, and promotions related to purchasing or leasing the property. The tour application or ancillary application may be programmed to query the user or prospect on preferences, such as, but not limited to, music preference, color preference, and areas of the single-family or condominium property the prospect would and would not like to visit on the tour.

The present disclosure may relate to a method of providing a tour utilizing the tour system for a retail center that may include shopping at locations, such as, but not limited to, an enclosed shopping mall, outdoor shopping mall, outlet mall, lifestyle center, neighborhood retail center, and/or a strip retail center (referred to as a “retail center”). The tour will allow a shopper or person only visiting a retail center (referred to as a “shopper”) to tour the retail center with the display device or additional display screen helping navigate the shopper through the retail center. A shopper could pre-select individual retail tenants within a retail center the Shopper intends to visit and the tour application or ancillary application could optimize the path through the Retail Center for the tour of the shopper. The tour system may show the shopper tour information, such as, but not limited to, information specific to the retail center including common area amenities, store directory, individual store layouts, information relating to amenities on-site and off-site of the retail center, and retail center gift cards, coupons, or discounts. The display device or additional display screen may allow the shopper to view promotions from retail center tenants and present those promotions to the shopper for discounts or other promotions on products. Ancillary information deemed of interest to a shopper based on information, such as, but not limited to, information related to retail tenants selected by the shopper to visit within the tour application or ancillary application and time spent at certain retail tenant stores could be sent to the prospect before, during, and after a tour, such as, but not limited to, information regarding promotions or marketing material from parties (e.g., the retail center, retail center tenants, or websites belonging to the retail center tenants), or third-party companies based on the shopping preferences of the shopper as gathered by the tour application or ancillary application. Given the eCommerce method of communication via the display device operating the tour application or the computing device operating the ancillary application before, during, or after the tour, one or more physical objects, such as, but not limited to, furniture, fixtures, electronics, and equipment may be displayed at subsidized pricing to the retail center owner or the retail center owner may be able to charge the owner of the physical objects to display such physical objects given the opportunity of the owner of the physical objects to market those physical objects for sale to the shopper.

The present disclosure may relate to a method of providing a tour utilizing the tour system for a business or a retail store that may include locations, such as, but not limited to, a grocery store, department store, electronics store, office supply store, home furnishings store, car dealership, jewelry store, clothing store, gyms, hard goods stores, soft goods stores, warehouse store, or discount retailer (referred to as a “retail store”). The tour will allow a shopper or person visiting a retail store (referred to as a “store shopper”) to tour the retail store with the display device or additional display screen helping to navigate the store shopper efficiently through the retail store. A store shopper could pre-select individual retail items or categories of items within a retail store that the store shopper intends to purchase or browse and the tour application or ancillary application could optimize the tour path of the store shopper through the retail store. The tour system may show the store shopper tour information, such as, but not limited to, information specific to the retail store including retail store layout, information relating to amenities on-site and off-site of the retail store, and retail store gift cards. The display device or additional display screen may allow the store shopper to view promotions from the retail store and present those promotions to the retail store for discounts or other promotions on products. Ancillary information deemed of interest to a store shopper based on information, such as, but not limited to, information related to retail items selected by the store shopper to purchase or browse within the tour application or ancillary application and time spent at certain retail store sections could be sent to the prospect before, during, and after a tour, such as, but not limited to, information regarding promotions or marketing material from parties, such as, but not limited to, the retail store or websites belonging to the retail store, or third-party companies based on the shopping preferences of the store shopper as gathered by the tour application or ancillary application.

The present disclosure may also relate to a method of gathering analytical data, such as the duration of time a user spends in certain areas during a tour, in the methods described in the above paragraphs. The tour will record how much time a user spends in proximity to each designated wireless device or a designated zone of interest to a real estate owner, such as, but not limited to, tracking the time a prospect spends in the outdoor areas, clubhouse, model unit, and fitness center on a tour. The tour may also solicit specific feedback from users about items, such as, but not limited to, thoughts or feedback related the property and/or the tour. The tour can further provide analytics and/or associated data to the real estate property owner or staff of the real estate property owner based on the collected data in the form of an email, short message service (“SMS”), any other form of digital communication, or directly through the ancillary application via the computing device.

The present disclosure may relate to a method of providing a tour utilizing the tour system where the tour application may provide navigation and other information to the user or prospect in areas outside of a traditional tour path, such as areas near or adjacent the tour path. A useful example of this would be if the property the user is touring is adjacent a restaurant. The tour application would then be able to include or modify the tour path to go by this restaurant. The user may then be offered information related to the restaurant, such as a menu or a complimentary drink or snack coupon code at the restaurant. This coupon code could additionally, for example, only be displayed as a result of certain parameters, such as if the user has been using the tour application for more than a predetermined amount of time (e.g., 30 minutes), the user already showed interest, or the user is within a predetermined distance from the area. The tour application may otherwise use recorded data according to certain parameters (e.g., total time on property) to inform and/or vary the pricing or specific available units (if in a multi-family property) displayed to a user at the end of the tour. Whether using recorded data or not, the tour application may use subconscious marketing and behavioral economic techniques including deliberate design, ordering, and highlighting user options in advantageous manners, loss aversion techniques, and typography to sway a user toward certain desired outcomes.

The present disclosure may relate to a method of providing a tour utilizing the tour system in which the tour application may provide a variety of benefits to user after the completion of the tour. Specific benefits may relate to items, such as automated follow-up measures (e.g., emails with video content) based on data recorded during the tour, photo capturing of users or prospects who plan to sign a lease for purposes of a photo directory of all residents to build community, or automatic sending of notes to the user via email or otherwise that the user may take about the property or tour via the tour application during or after the tour.

The present disclosure relates to a system and method that allows a customer, visitor, employee of a real estate property, or other user to tour, shop, or learn about the real estate property and the physical layout and contents of the property utilizing wireless technology or similar signals projected from hardware installed at the property and communicating to a handheld piece of hardware to provide appropriate information on a tour. Further, as real estate properties can contain long corridors or may be confined to small spaces, directional or intensity refinement of the wireless technology or similar signals may be needed. For example, a wireless device cover (e.g., RF shield) that limits the direction or intensity of the signal emitted from the wireless devices could be used in the present disclosure. The overlay that will incorporate a wireless device cover encompassing the wireless device can also act as directional signage in order for users to follow the intended path.

As mentioned above, a system and method for providing a tour while eliminating or reducing the need for a human guide or salesperson. Certain embodiments of the present disclosure include, but are not limited to, a system that will utilize a display device with the capability to receive a combination of tracking, positioning, and event triggering related information from wireless devices. The display device may also wirelessly communicate with additional display screens to show tour information or ancillary information. The wireless device may use low energy Bluetooth technology or any similar type of signal technology, in which one or more wireless devices will be set in a manner in which an intended path of travel for the tour can be determined by the display device position relative to the field of wireless devices. The wireless devices will transmit wireless signals that allow the system to gain positioning information and/or acknowledge the arrival of a user to an intended location or path where the display device will exhibit information or interact with the user. As mentioned above, such information may include, but is not limited to: video information, picture information, textual information, audio information or music, interactive information obtained through wireless communication such as media from the internet, sales information, and/or navigation information. Tour information may be conveyed in different or multiple languages or other styles of communication. The tour application may also allow a user to communicate with knowledgeable individuals (e.g., property staff members) before, during, or after a tour. This may be done in the form of a video, audio, or text feed or chat.

The display device will be programmed with or use a tour application program that will coordinate the tour. A computing device located on-site or off-site of the location of the tour may be utilized to communicate with the user prior to, during, and/or following the tour to provide tour information or ancillary information that is deemed relevant to the user given the nature of the tour. Ancillary information may include, but is not limited to: video information, picture information, textual information, audio information or music, interactive information obtained through wireless communication such as media from the internet, sales information, and/or navigation information.

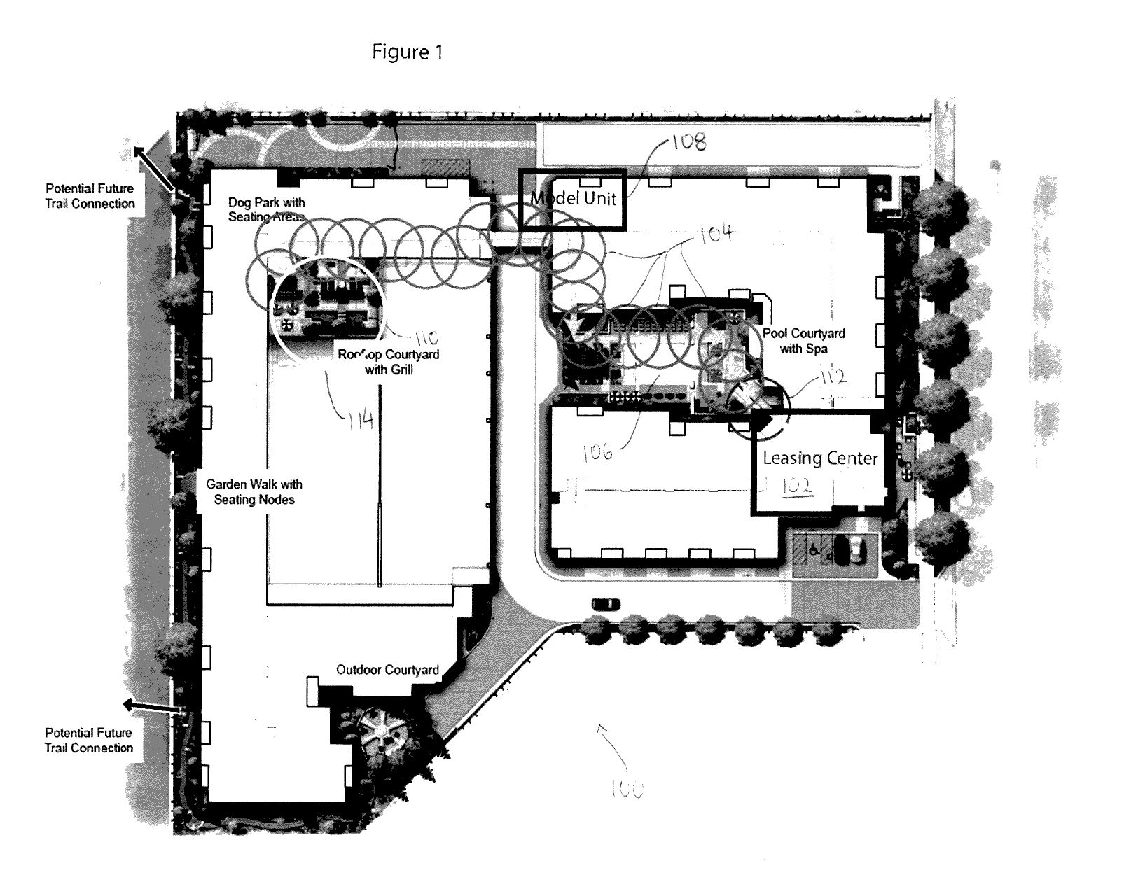

FIG. 1 shows a top down view of the use of the tour system in accordance with one or more embodiments of the present disclosure. In this embodiment, the tour may be conducted within a multi-family property 100 where the user is given a display device in a leasing center 102 or the smartphone or tablet of the user that is loaded or connected with a tour application to become the display device. The user is able to tour the multi-family property 100 independently along an intended tour path 104. The tour path 104 is denoted by circles that may represent the circumference of a wireless signal (e.g., a transmitted low energy Bluetooth or similar signal) from a wireless device. The passage of the user through the wireless signal and interaction between the wireless device with the tour application on the display device may indicate the location of the user on the property. The intended tour path 104 of the multi-family property 100 in FIG. 1 goes the leasing center 102, through an outdoor amenity area 106, into a model unit 108. The tour path 104 may continue along up an elevator to a roof top deck 110, and then continue back along the same path to the leasing center 102. Upon the passage of the user through specific pre-determined areas or within a pre-determined proximity of a physical object, the tour application will display tour information specific to the pre-determined area or physical object. For example, the area represented by the circle 112 adjacent the leasing center 102 may provide information to the user about the outdoor amenities 106 of the property 100, and the area represented by the circle 114 adjacent the rooftop courtyard 114 may provide information to the user about the rooftop amenity area 114. Such information may include tour information or ancillary information. Further, given the large expanses of a multi-family property, a wireless device cover, such as an overlay and/or a RF Shield, may be used as directional markers for the tour.

The tour application may feature a security mechanism that alerts multi-family property staff and/or the user if a user is leaving the intended tour path 104 or area with wireless signals. The tour application may also have a security feature, such as an accelerometer or other motion sensor, with the display device to ensure that the user is, in fact, carrying the display device and not deviating from the tour path 104. Further, the tour application may have a security feature that uses any type of near-field or wireless communication (such as low energy Bluetooth) within the display device to detect if two or more display devices running the tour application become too close to each other (i.e., within a predetermined distance from each other). This may prevent multiple users touring together from having one person hold all Display Devices to render the aforementioned tour deviation security features ineffective.

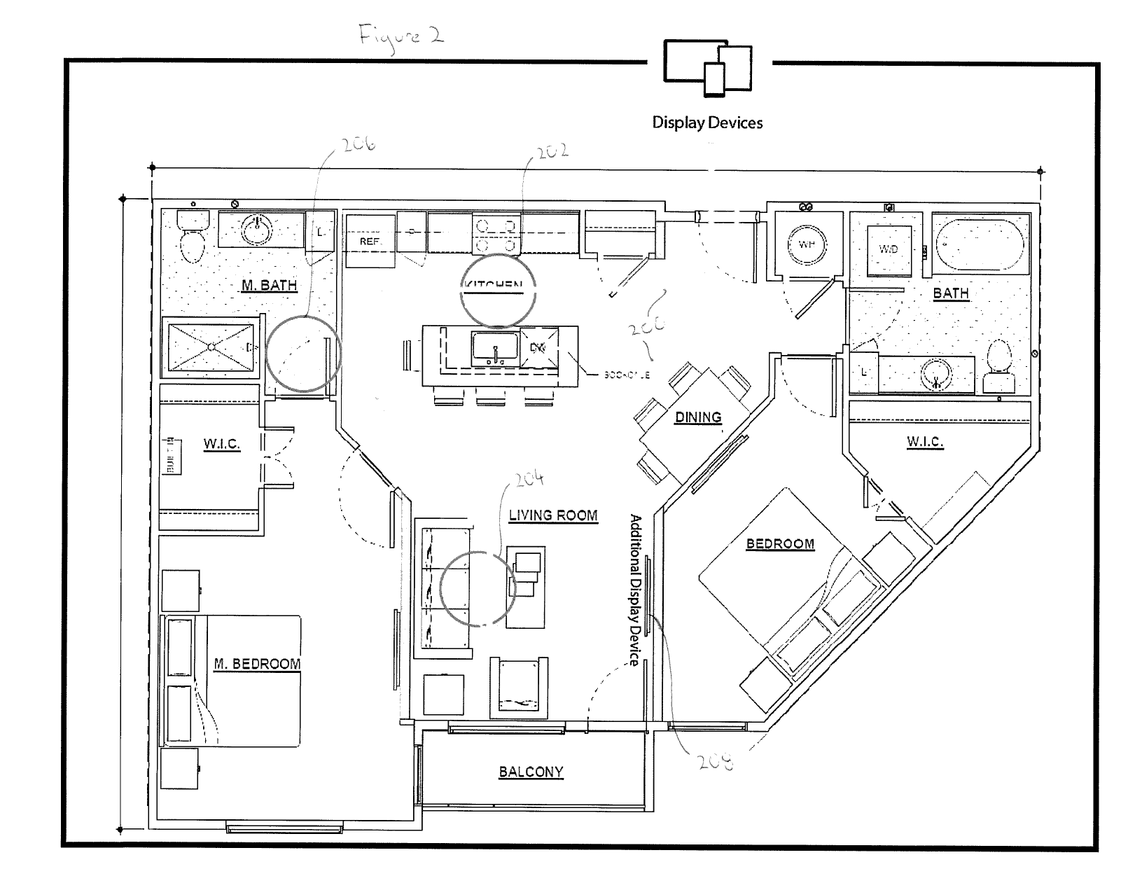

FIG. 2 shows a top down view of the use of the tour system within the model unit 108. The user carries the display device through the unit 108 along the tour path 200 indicated with arrows. The circles in the kitchen 202, living room 204, and master bathroom 206 represent examples of the circumference of a transmitted wireless signal where upon the passage of the user or display device through the field of the wireless signal, the display device will display tour information or ancillary information. Within the model unit 108 is an example of an additional display screen 208. In this embodiment, the additional display screen 208 includes a flat panel display that can display tour information or ancillary information, such as when the user enters the living room area 204 adjacent the additional display screen 208.

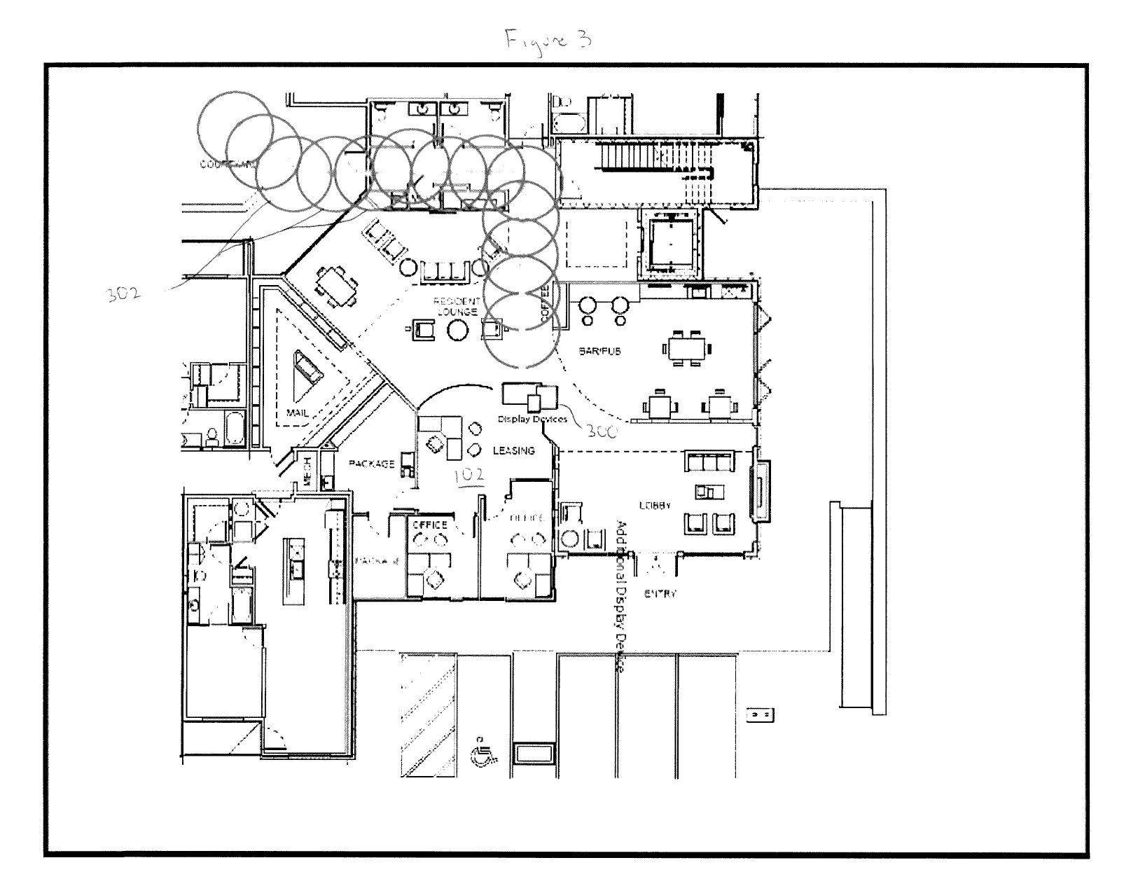

FIG. 3 shows a top down view of the use of the tour system within the multi-family leasing center 102 in accordance with one or more embodiments of the present disclosure. As indicated, the user is given a display device 300 or smartphone, tablet, or other portable device of the user is loaded or in communication with a tour application to become the display device 300. The user may start the tour along the intended tour path 302, which is denoted by the circles that represent the circumference of wireless devices. At the start of the tour, the tour application or ancillary application may be programmed to query the user or prospect on preferences, such as, but not limited to, music preference, color preference, apartment configuration preference, and/or areas of the multi-family property the user would and would not like to be on the tour. The tour application thereafter may be able to direct the user to a customized tour given these preferences, such as, but not limited to, directing the user to only the desired tour destinations, including only the preferred multi-family or multi-unit condominium unit size and configuration, in which the preferred music of the user is played in an external audio device or the display device. Upon the return user to the leasing center 102, the display device or an additional display screen with the tour application program may allow the user or prospect to apply for and/or sign a lease with the property or offer to purchase a unit at the property. The tour application program may allow for an electronically signed lease or sales document, such as through the program in-part or in-whole, and may be performed or executed electronically such that all parties need not be present.

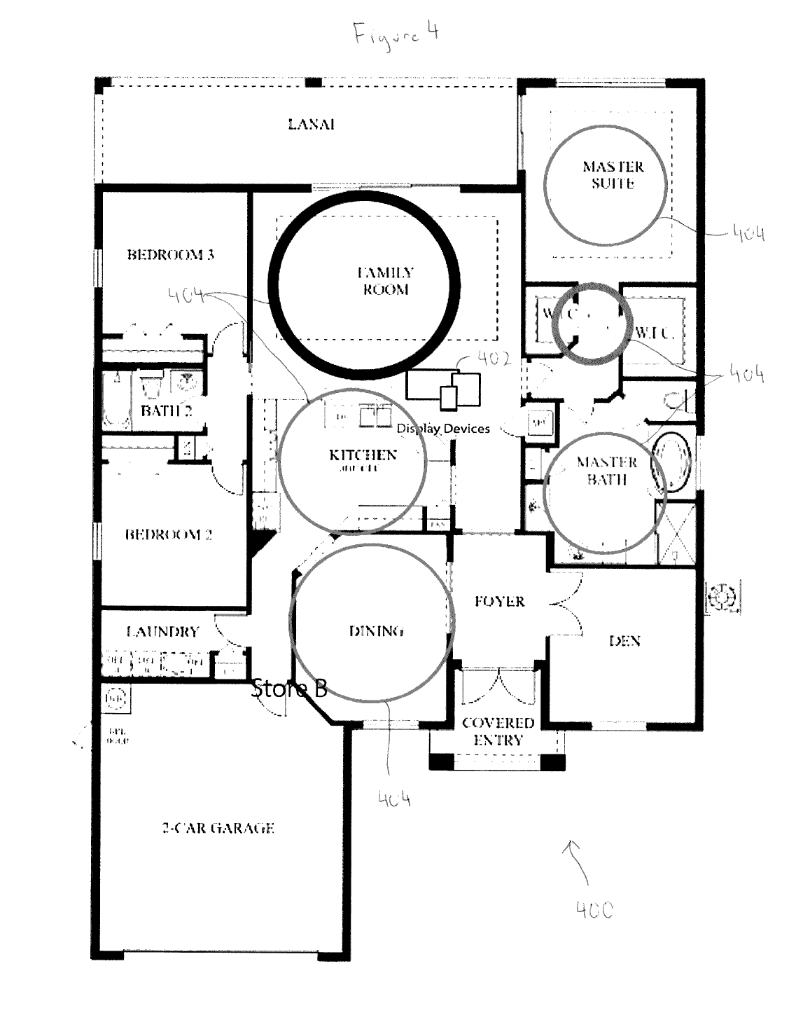

FIG. 4 shows a top down view of the use of the tour system within a single family home or condominium property 400 in accordance with one or more embodiments of the present disclosure. As shown, the user (e.g., prospect) is able to pick up and use a display device 402 that is already in the property 400, such as on a kitchen countertop, or may use a smartphone, tablet, or other portable device of the user that is loaded or in communication with a tour application to become the display device 402 to begin the tour of the property 400. The circles 404 in the property 400 represent examples of the varying circumferences of transmitted signal of wireless devices with varying power levels, where upon the passage of the user through the field of transmitted signal in the circles 404, the display device 402 will display tour information pertaining to each individual area of the property 400. The tour application may allow for an electronically signed lease or sales document, such as through the program in-part or in-whole, and may be performed or executed electronically such that all parties need not be present.

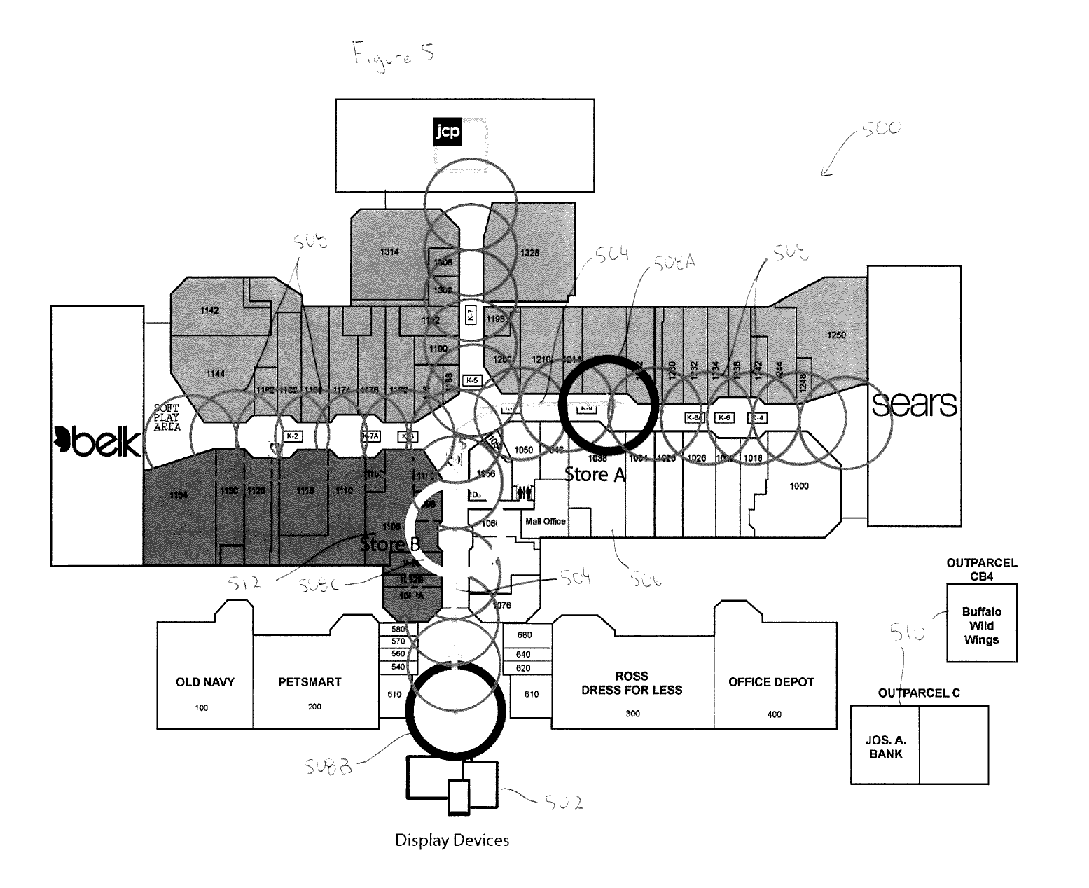

FIG. 5 shows a top down view of the use of the tour system within a retail center 500 where the user, (e.g., shopper) may carry a display device 502 through the retail center 500 along a tour path 504 indicated by arrows. Prior to the or during the tour or visit to the retail center 500, the user denotes an intention to visit Store A 506, which may be designated as a certain type of or specialized store (e.g., a children's apparel store), within the tour application or ancillary application. The circles 508 in the corridors of the retail center 500 represent examples of the circumference of transmitted signals from wireless devices, where upon the passage of the user through the fields 508, the display device 502 utilizing the tour application will be able to locate and track the position of the user within the retail center 500. Given the intended path 504 of the user, the tour application and display device will direct the user to Store A 506 within the circle or field 508A adjacent Store A 506. At the moment or when the user enters the circle or field 508B adjacent an entrance of the retail center 500, the display device may display information specific to the retail center 500 including, but not limited to, common area amenities, store directory, individual store layouts, information relating to amenities on-site and off-site (e.g., outparcels 510) of the retail center 500, and/or gift cards related to the retail center 500. Given the programming of the tour application and ancillary application that cross-references the preferences of the user (e.g., children's apparel store to children's footwear store), the user may be presented with advertisement or a promotion from related stores (e.g., Store B 512, a children's footwear store, when crossing the circle or field 508C adjacent Store B 512).

FIG. 6 shows a top down view of the use of the tour system within a retail store 600, such as a grocery store, in accordance with one or more embodiments of the present disclosure. In this embodiment, the entirety of the retail store 600 available to the public by a user is covered by transmitted signals from wireless devices, thereby allowing the display device 602 and tour application to locate and track the position of the user through the retail store 600 to guide the user. In this case, as the user intends to shop at a grocery store, the user may input a shopping list, such as certain ingredients to bake an apple pie including apples, all-purpose flour, and butter. The tour application may include pre-selected shopping lists that the user can deselect items already in the possession of the user, or the tour application may analyze the shopping list or inputs of the user to acknowledge the desire of the user to prepare a particular dish or meal (e.g., bake an apple pie).

Upon the arrival of the user at the grocery store, the tour application on the display device 602, which may be the smartphone, tablet, or other display device of the user, will direct the user on an intended tour path 604 denoted by arrows, which may be a route for the Store Shopper (e.g., the most efficient by expected time or distance traveled) or a route determined to be most profitable for the owner of the store 600. The display device 602 may allow the user to view promotions or coupons from the retail store 600 and present those promotions to the retail store 600 for discounts or other promotions on products or services sold at the retail store 600. The tour application may also upsell or cross-sell when the user is in certain areas of pre-designated interest within the retail store 600. For example, with respect to baking a pie, when the user is in the baking items aisle denoted by the double ended arrow 604A, the Tour Application may present the user with the option to purchase items, such as, but not limited to, sugar or a cake mix After the user picks up the last item (e.g., butter) in the last visited section (e.g., dairy) of the store 600, the tour application may direct the user into areas of the store 600 not yet visited. Such items that are complimentary to interests of a user (e.g., person baking an apple pie) could be then presented, such as ice cream in the frozen items section. Upon arriving at checkout, the tour application may automatically show all coupons and discounts to the cashier. The tour application may also be able to calculate or estimate a potential cost for the items to be purchased by the user, such as to enable the user to budget for the items on a shopping list before checking out, or even keep track of all items the user plans to purchase and accept payment for the purchase prior to exiting the store.

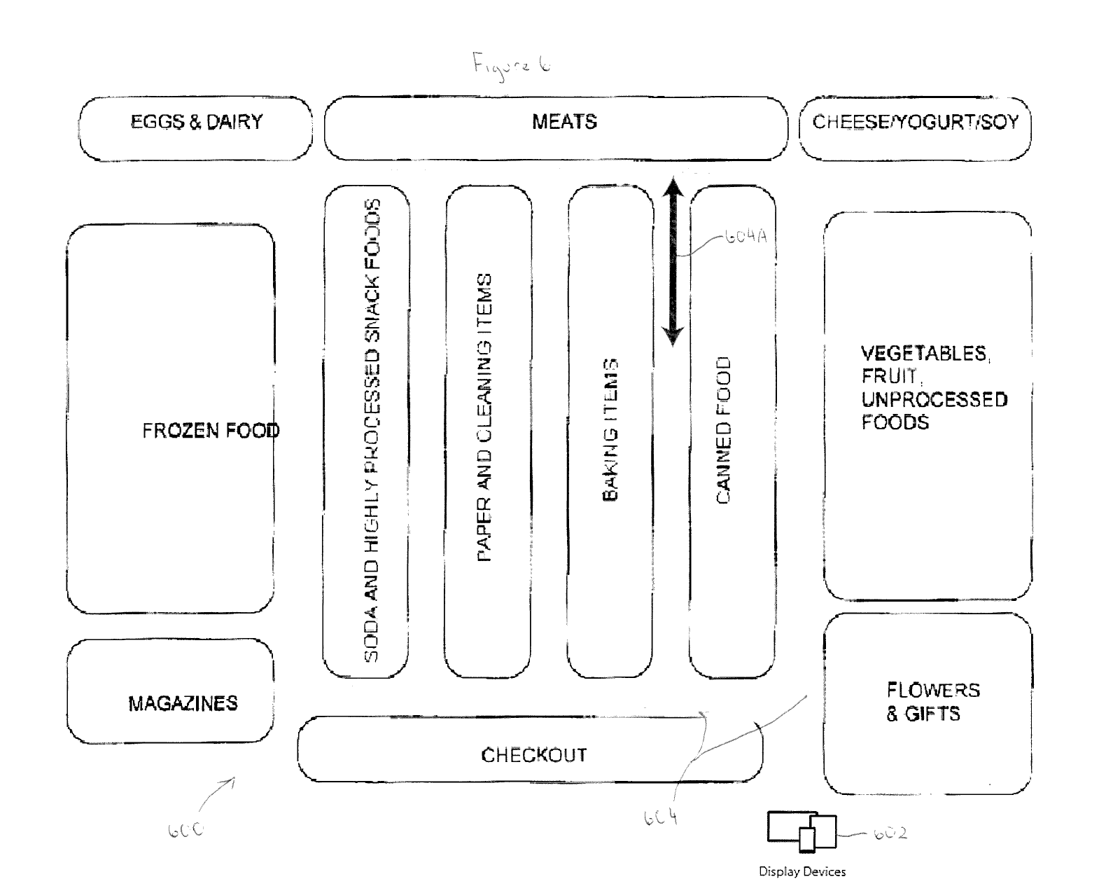

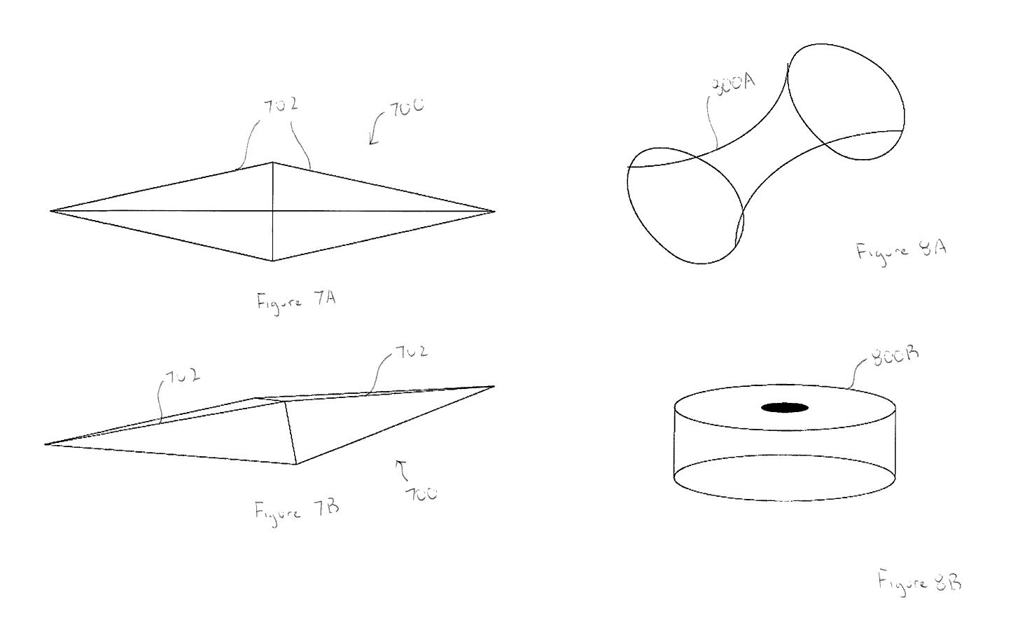

FIGS. 7A and B show multiple views of a wayfinding overlay 700 that may be used to cover an individual wireless device and/or a wireless device cover. FIG. 7A shows a top down view of the overlay 700, and FIG. 7B shows an oblique view of the overlay 700. The overlay 700 is not limited to any particular shape or size, and may be configured based upon the particular application, the overlay 700. However, in FIGS. 7A and 7B, the overlay 700 is shown as having a diamond shape with each side forming a separate arrow 702. Each arrow 702 may be represented in a tour application, and may be distinct from each other (such as by having different colors) that may allow a user to follow a particular arrow 702 of the overlay 700 as instructed by the tour application on a display device. The arrows 702 on the wayfinding overlay 700 do not necessarily need to form arrows in opposing directions (e.g., 180 degrees from each other), rather the arrows 702 can form 90 degree angles or other angles that mimic or designate an intended tour path. If the intended tour path is a path that instructs the user to go out to a final destination and return on the same path at some point, the tour application can reference the color or other distinctive characteristic of the arrows 702 on the wayfinding overlay to point away from the tour origin on the path of the user to the final destination and the opposing color or other opposing distinctive characteristic of the arrows 702 on the wayfinding overlay to point to the tour origin on the path of the user, as needed.

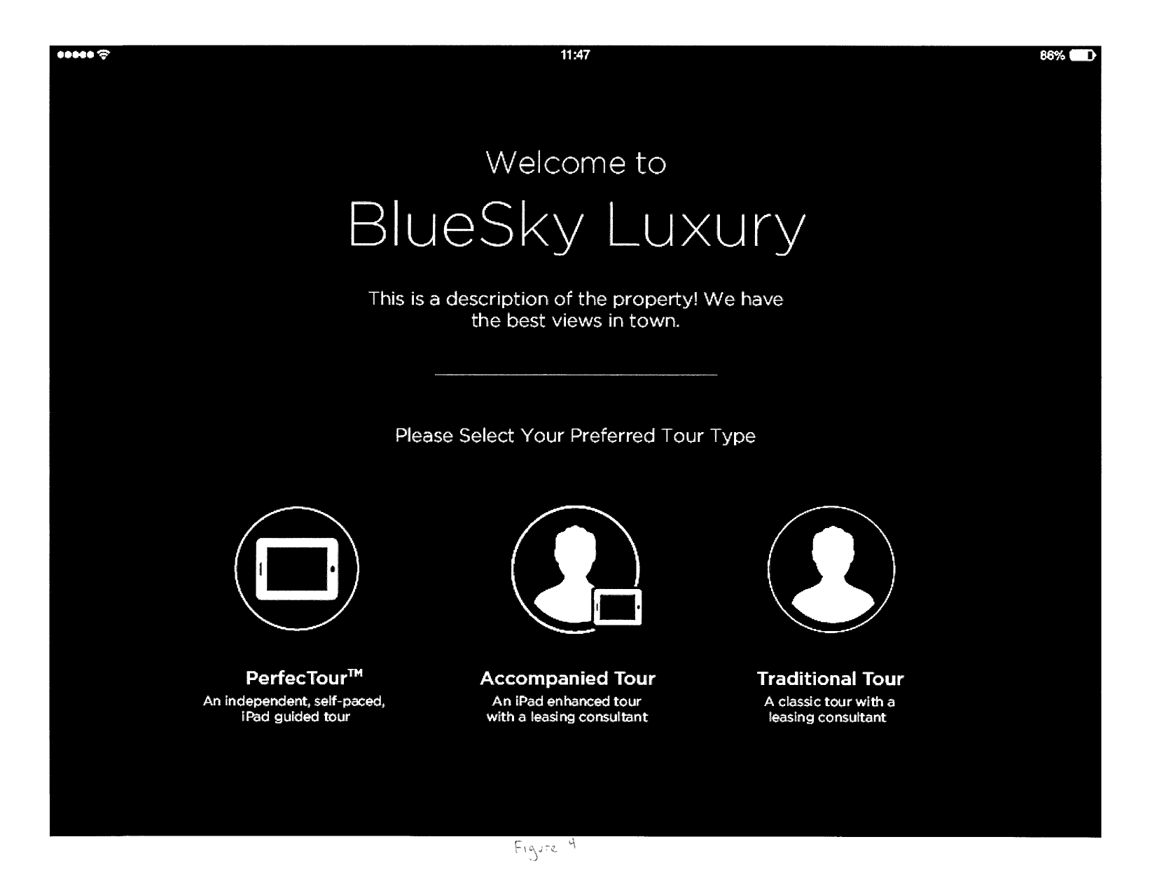

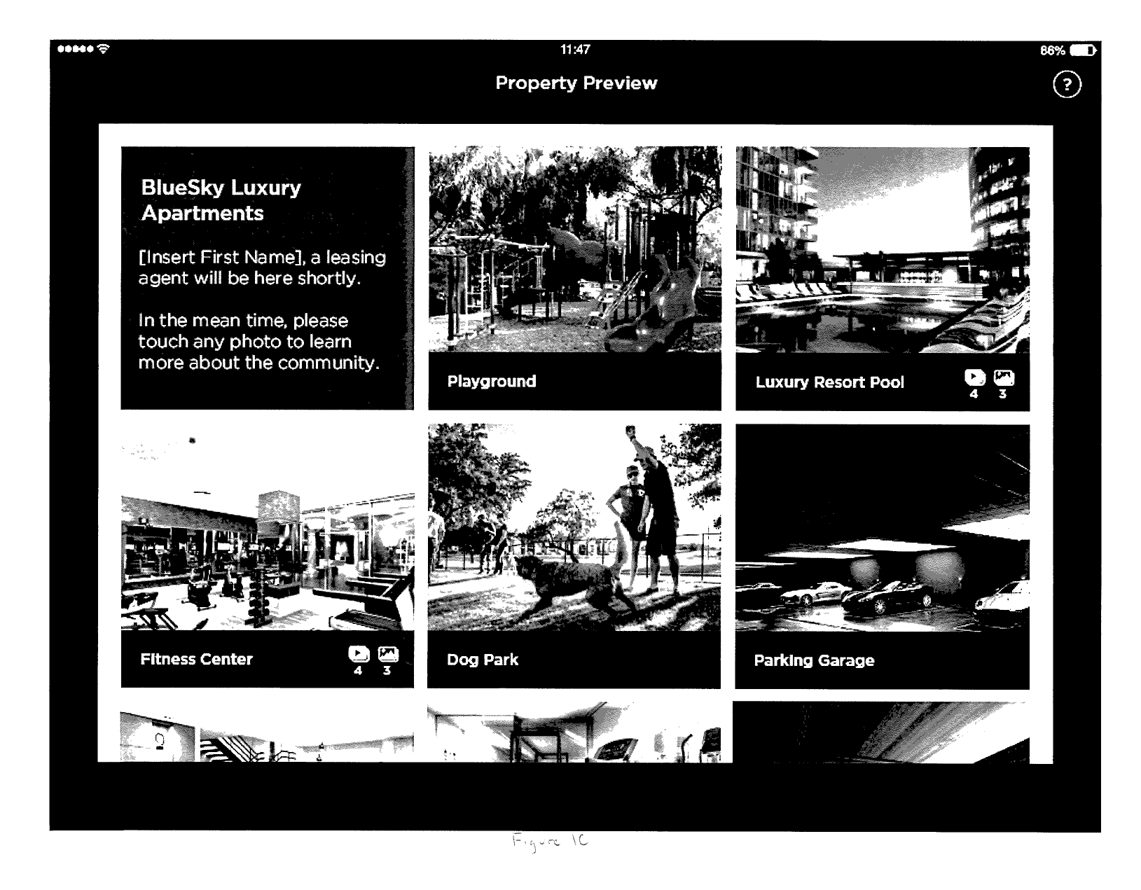

FIGS. 8A and 8B show multiple views of a wireless device covers in accordance with one or more embodiments of the present disclosure. A wireless device cover, such as a RF shield, may cover and shield the signal from a wireless device, such as by calibrating the direction or intensity of the wireless signal to suit an intended tour path. In FIG. 8A, the wireless device cover 800A may be positioned about or around a wireless device, in which the wireless device cover 800A may shield or cover the direction or intensity of the signal from a wireless device to suit an intended tour path down a long corridor. In FIG. 8B, the wireless device cover 800B may be positioned about or around a wireless device, in which the wireless device cover 800B may shield or cover the direction or intensity of the signal from a wireless device to suit a small area, such as a location where multiple wireless devices may be located near each other and the intended signal broadcast distance by one or more wireless devices is intended to be a short distance that will only trigger the display device when within close proximity to the wireless device within the cover 800B.

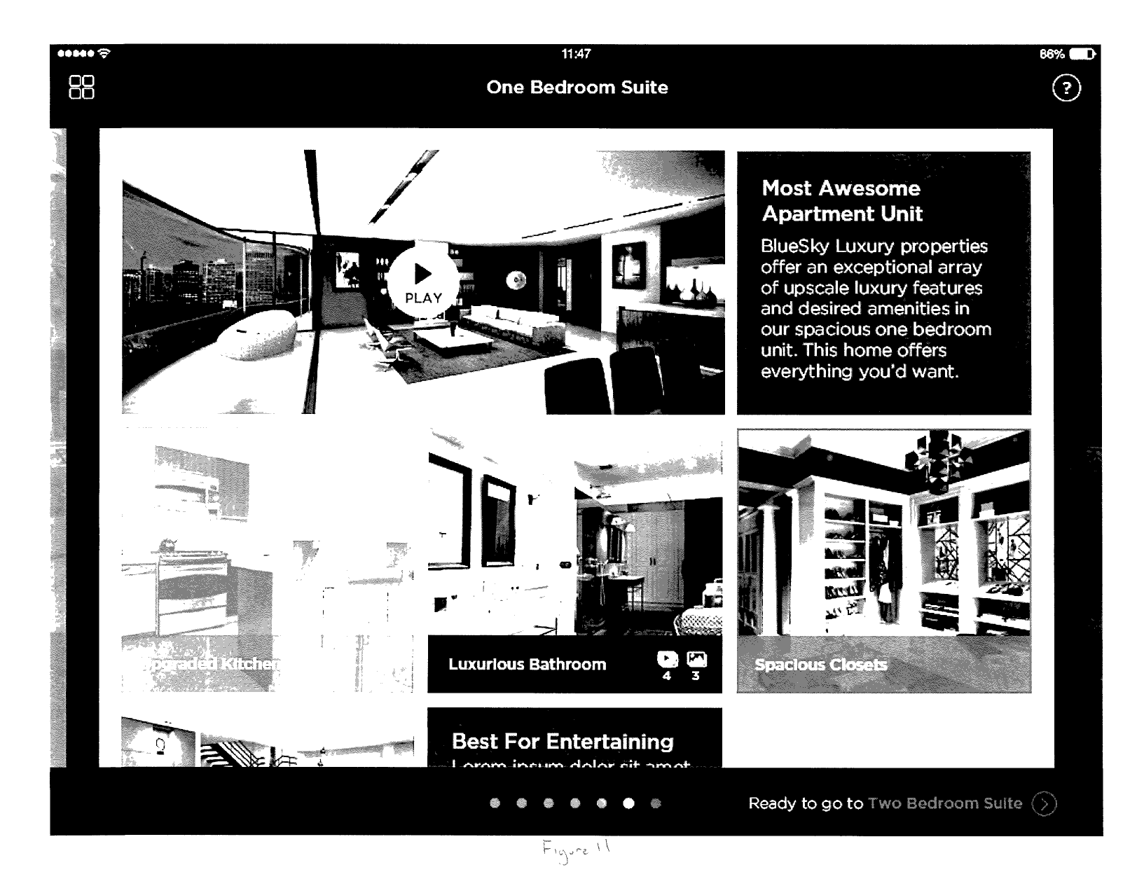

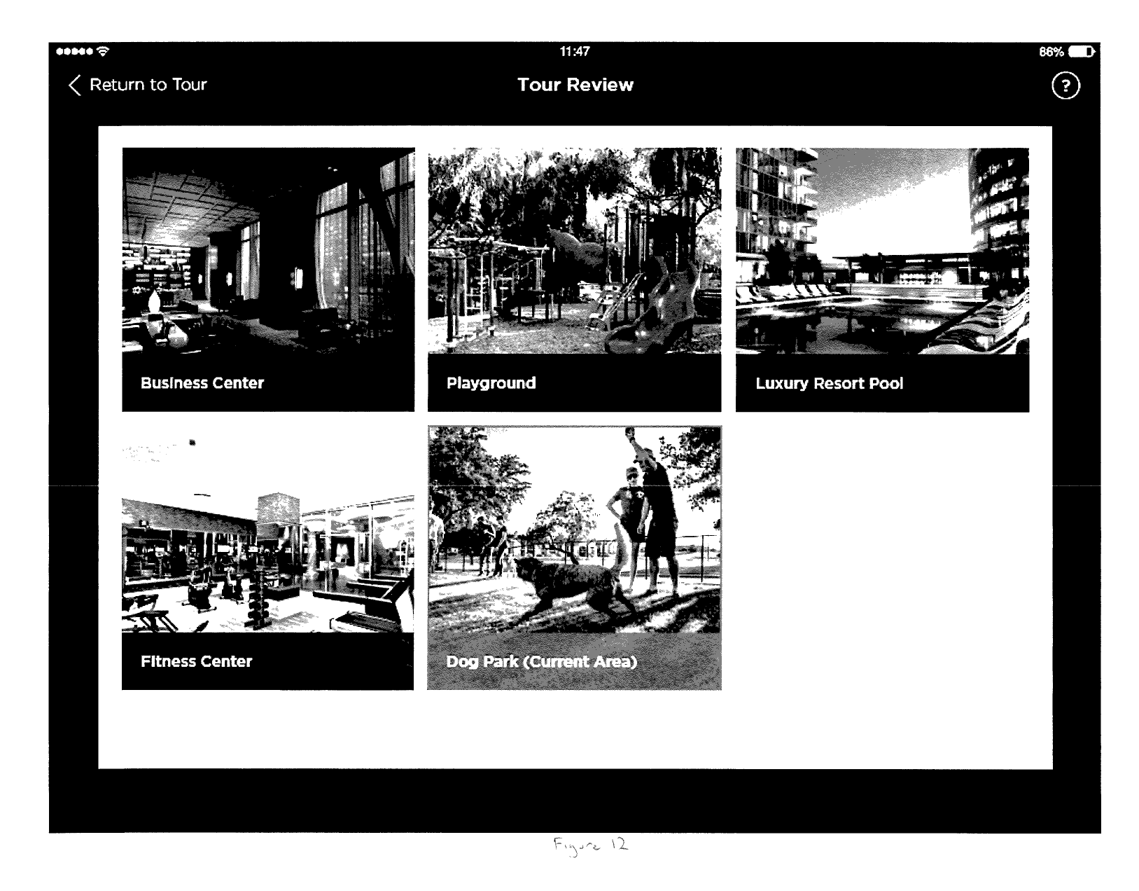

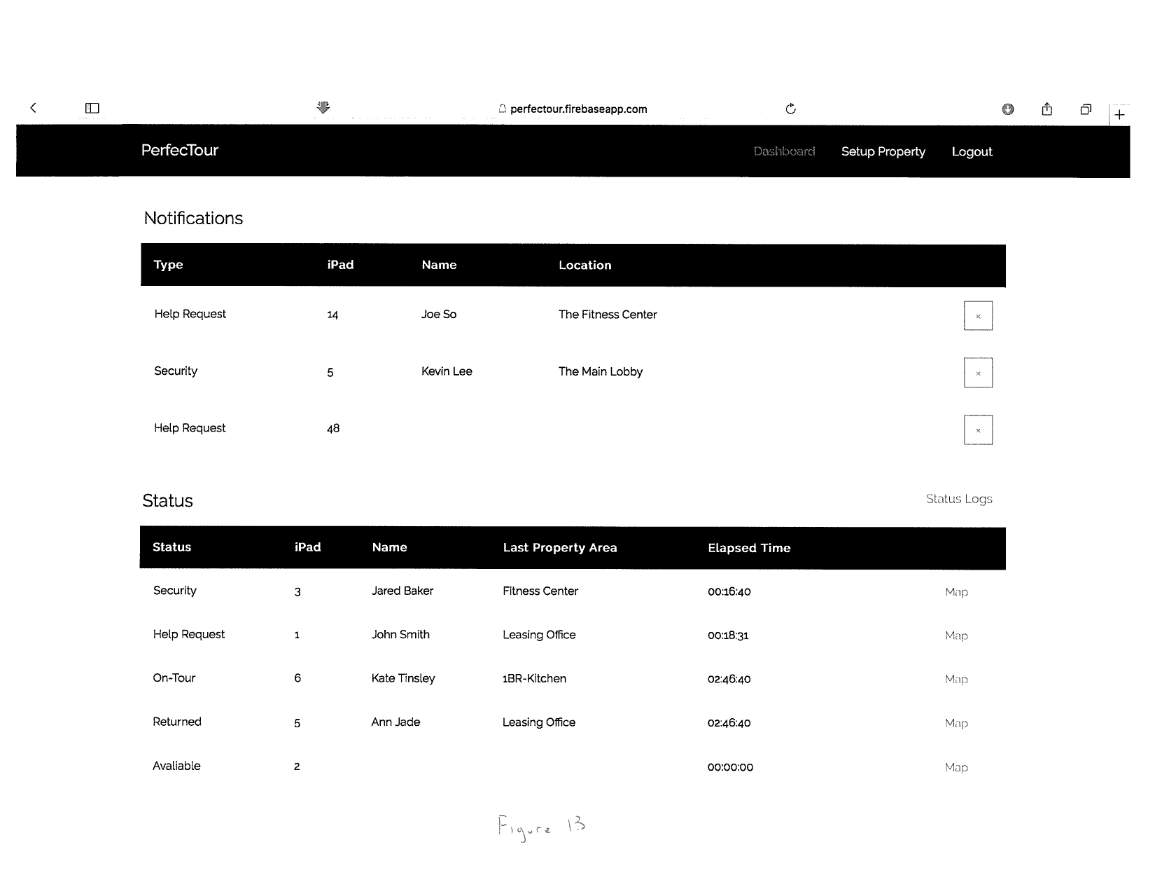

Further, additional FIGS. 9-12 provide views of a user interface in accordance with one or more embodiments of the present disclosure. The user interface may be provided on a display of an electronic device/display device such that a user may interact with the tour application. FIG. 9 shows an example of the user interface of the tour application in which the user may select between a tour using a display device and tour application only, a tour using a display device and tour application that is supplemented with an in-person tour, or an in-person only tour. FIG. 10 shows an example of the user interface of the tour application in which the user is shown an outline or preview of the tour, in which the user may preview areas and details of the property prior to beginning the tour (this may be useful when a user has to wait for a friend or family member to begin the tour, for example). FIG. 11 shows an example of the user interface of the tour application in which the user has reached a position or destination within the tour, and the tour application is then displaying information to the user related to the specific position or destination. FIG. 12 shows an example of the user interface of the tour application in which the user is shown a review of the tour, in which the user may select positions or destination that were included on the tour for review. The present disclosure is not limited to the depicted embodiments, as one having ordinary skill in the art will appreciate that other arrangements may be used for a user interface without departing from the scope of the present disclosure.

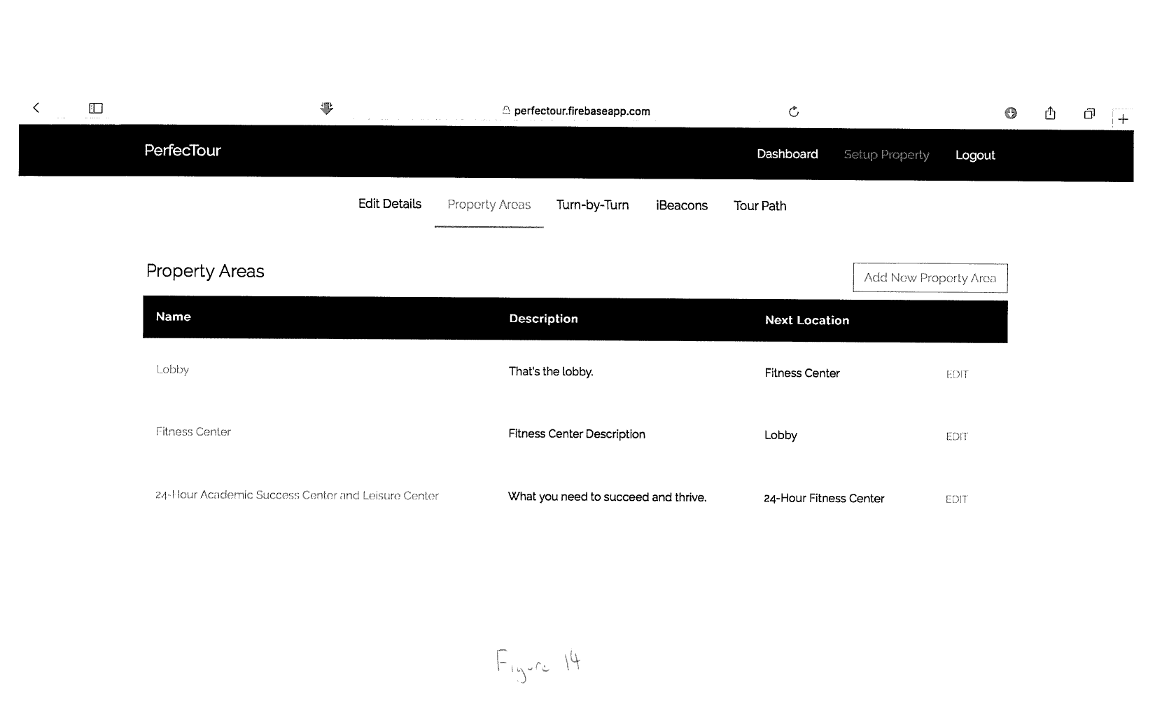

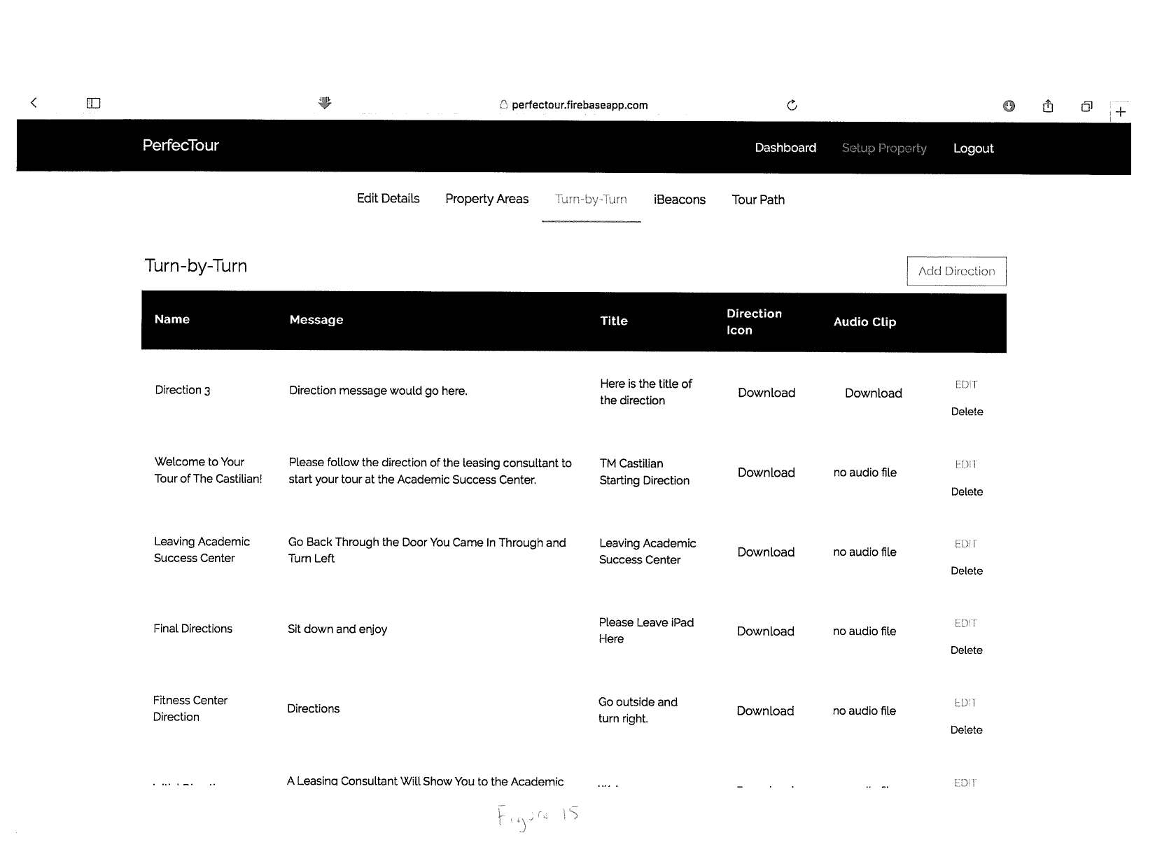

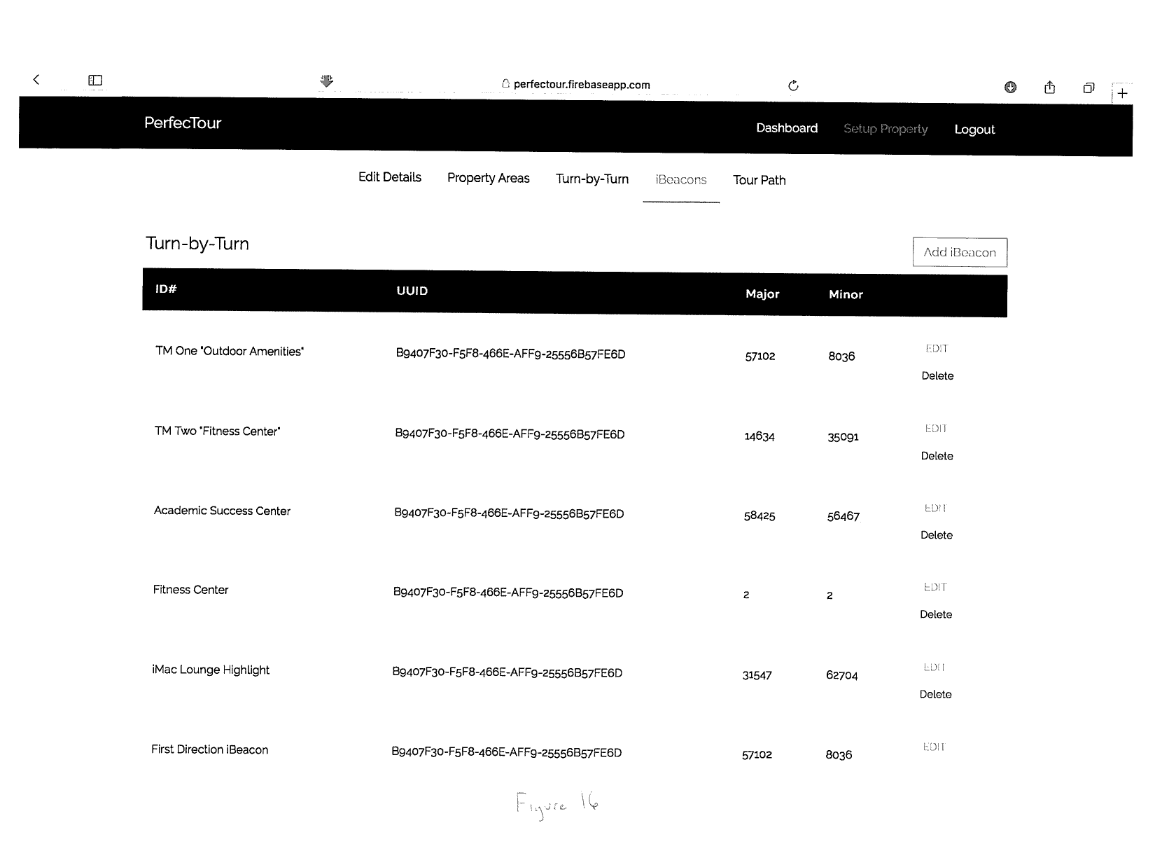

Furthermore, additional FIGS. 13-16 provide views of a dashboard or user interface of a computing device in accordance with one or more embodiments of the present disclosure. The computing device may act as a server or overall computing device or control a server or overall computing device to manage the location and service to one or more individual display devices. The computing device may also act as a server or overall computing device or control a server or overall computing device to manage the location and service to one or more wireless devices. FIG. 13 shows an example of a dashboard or user interface of a computing device to manage multiple display devices (e.g., “iPads”). The dashboard may give a notification based upon certain circumstances. In this embodiment, a security notification may be generated, such as in the case that a user or display device is no longer on a predetermined tour path or moving at a predetermined rate or pace, and a help request notification may be generated, such as in the case a user has requested help or assistance with a display device along the tour. The dashboard may enable the computing device to interact with the display device in real-time, such as through video chat or another stream, to then connect a user of the computing device with the user of the display device. The dashboard also may indicate a potential last determined position along the tour (e.g., “Last Property Area”), and an overall amount of time on the tour (e.g., “Elapsed Time”), amongst one or more other features. FIG. 14 shows an example of a dashboard or user interface of a computing device with the different positions or property areas included within a property, and FIG. 15 shows an example of a dashboard or user interface of a computing device with the different turn-by-turn positions included within a property. FIG. 16 then shows an example of a dashboard or user interface of a computing device to manage multiple wireless devices (e.g., “iBeacons”). The wireless devices may be related or correspond to the positions shown in FIGS. 14 and 15, in which the wireless device may be a property area wireless device (positioned in specific areas of the property to designate a potential area-of-interest) or a turn-by-turn wireless device (positioned in specific areas of the property to provide navigation and facilitate movement along a tour path between potential areas-of-interest). The wireless device may also be a message or success wireless device (positioned in specific areas of the property to provide messages to the user) and/or highlight wireless devices (positioned in specific areas of the property to designate a highlight of the property). The dashboard may provide a status on one or more of the wireless devices, along with the position of the wireless device, and/or a message associated with the wireless device that is communicated to the user of a display device. The present disclosure is not limited to the depicted embodiments, as one having ordinary skill in the art will appreciate that other arrangements may be used for a dashboard without departing from the scope of the present disclosure.

In one or more embodiments, upon the opening or launch of the tour application within the display device or display device itself, the tour application and the display device may download, either from the computing device or with previously set direction via the computing device, any and all information (e.g., media and content) related to running and using the tour application and the display device through the completion of the informational tour. For example, when conducting a tour, the display device may receive and detect a position signal from a wireless device with the wireless device arranged at a position along the tour. When or after the display device detects the position signal, the display device may then output information based upon the position signal or related to the position along the tour. This information may be already preloaded on the display device within the tour application (e.g., upon activation or launch) before any detecting of the position signal, such that display device does not require the receipt of information (e.g., media and content) upon receiving any position-related information from the wireless device and/or the computing device to output the position-related information. As mentioned, the display device may download this information upon opening or launch from the computing device or through the computing device (such as through an admin portal included at the computing device), or at least verify that the information on the display device is current and does not need to be updated or re-downloaded. The information may then be stored and output/displayed locally from the display device through the tour application through the entirety of the information tour. This may allow the display device to more seamlessly provide information to a user using the tour application and display device without burdening or relying on other resources, such as a wireless network or internet. In one or more embodiments, the tour application and the display device may send data to the computing device before, during, or after a tour, such as data related to elapsed tour time, total tour time, current location, or various user inputs (e.g., welcome form info). However, unless the data or communication requires two-way streaming (e.g., video or text chat), the tour application and the display device do not require streaming or downloading of information during a tour.

In one or more embodiments, as mentioned above, a wireless device may emit a position signal from a position along an informational tour. The position signal may relate and be unique to the wireless device. However, the position signal may not include other information related to the position of the wireless device but rather signal another intended action for the tour application and display device. For example, if a wireless device is positioned within a rental unit within a rental property, the wireless device may emit a signal that denotes and is unique to the wireless device that the display device is in proximity of the wireless device. However, the signal emitted from the wireless device may contain information unrelated to the position itself but rather non-position related information or intended actions (e.g., information related to the rental unit or rental property). Rather, as the tour application and the display device may already include or have downloaded the position-related information, upon detection of the position signal from the wireless device, the tour application and the display device may then output the position-related information, such as the media or content related to the position. The tour application and the display device may be pre-programmed to associate the signal from the wireless device with the position and the information related to the position. As the tour may contain multiple wireless devices, each emitting a unique signal, the tour application and the display device detecting each of these signals may associate each signal with a different position and/or different information related to and unique to each position. This may allow the display device to more seamlessly provide information to a user using the tour application and display device without requiring additional information to be communicated between the wireless device and the display device.

This discussion is directed to various embodiments of the invention. The drawing figures are not necessarily to scale. Certain features of the embodiments may be shown exaggerated in scale or in somewhat schematic form and some details of conventional elements may not be shown in the interest of clarity and conciseness. Although one or more of these embodiments may be preferred, the embodiments disclosed should not be interpreted, or otherwise used, as limiting the scope of the disclosure, including the claims. It is to be fully recognized that the different teachings of the embodiments discussed may be employed separately or in any suitable combination to produce desired results. In addition, one skilled in the art will understand that the description has broad application, and the discussion of any embodiment is meant only to be exemplary of that embodiment, and not intended to intimate that the scope of the disclosure, including the claims, is limited to that embodiment.

Certain terms are used throughout the description and claims to refer to particular features or components. As one skilled in the art will appreciate, different persons may refer to the same feature or component by different names. This document does not intend to distinguish between components or features that differ in name but not function, unless specifically stated. In the discussion and in the claims, the terms “including” and “comprising” are used in an open-ended fashion, and thus should be interpreted to mean “including, but not limited to . . . . ” Also, the term “couple” or “couples” is intended to mean either an indirect or direct connection. The use of “top,” “bottom,” “above,” “below,” and variations of these terms is made for convenience, but does not require any particular orientation of the components.

Reference throughout this specification to “one embodiment,” “an embodiment,” or similar language means that a particular feature, structure, or characteristic described in connection with the embodiment may be included in at least one embodiment of the present disclosure. Thus, appearances of the phrases “in one embodiment,” “in an embodiment,” and similar language throughout this specification may, but do not necessarily, all refer to the same embodiment.

Although the present invention has been described with respect to specific details, it is not intended that such details should be regarded as limitations on the scope of the invention, except to the extent that they are included in the accompanying claims.

What is claimed is:

1. A method to provide a user an informational tour of a location, the method comprising:
emitting a position signal from a wireless device at a position along the informational tour;
detecting the position signal with an electronic device; and
outputting information based upon the position signal with the electronic device.

2. The method of claim 1, wherein:
the wireless device comprises a Bluetooth device;
emitting the position signal comprises emitting a Bluetooth signal; and
detecting the position signal comprises detecting the Bluetooth signal.

3. The method of claim 1, wherein the location comprises a multi-family property, a condominium property, a single family property, a retail center, a retail store, an educational property, a park, or a museum.

4. The method of claim 1, wherein the information comprises audio information, video information, picture information, textual information, or navigational information.

5. The method of claim 1, wherein:
the information is based upon the position along the information tour;
the outputting the information comprises outputting the information to the user; and
the outputting the information comprises outputting the information through a tour application installed on the electronic device.

6. The method of claim 1, further comprising shielding a direction or an intensity of the position signal with a wireless device cover.

7. The method of claim 1, further comprising:
emitting a second position signal from a second wireless device at a second position along the informational tour;
detecting the second position signal with the electronic device; and
outputting information based upon the second position signal with the electronic device.

8. The method of claim 1, wherein:
the electronic device comprises a display device; and
the outputting the information comprises displaying the information based upon the position signal with the display device.

9. The method of claim 1, further comprising:
sending the position signal from the electronic device to a computing device; and
sending the information based upon the position signal from the computing device to the electronic device.

10. The method of claim 9, wherein the sending the information comprises one of:
downloading the information from the computing device to the electronic device before detecting the position signal; and
streaming the information from the computing device to the electronic device to output the information.

11. The method of claim 1, further comprising:
downloading all of the information from the computing device to the electronic device at one time with such information associated with position signals emitted from wireless devices; and
displaying information associated with a position signal upon the electronic device detecting the position signal emitted from a wireless device.

12. The method of claim 1, wherein:
the electronic device is configured to track each at least one of an elapsed tour time of the user, a total tour time of the user, and time the user is in proximity to the position signal; and
the electronic device is configured to receive and store user inputted information pertaining to the informational tour.

13. The method of claim 1, wherein:
the emitting the position signal from the wireless device comprises emitting only the position signal from the wireless device; and
the position signal comprises only an identifier unique to the wireless device.

14. The method of claim 1, further comprising:
receiving a selection from the user to add the position along the informational tour; and
directing the user to the position along the informational tour with the electronic device.

15. A system to provide a user an informational tour of a location, the system comprising:
a wireless device configured to be arranged at a position along the informational tour and emit a position signal; and
an electronic device configured to detect the position signal and output information based upon the detected position signal.

16. The system of claim 15, wherein the electronic device comprises a display screen and is configured to display the information based upon the detected position signal.

17. The system of claim 15, further comprising a wireless device cover configured to shield a direction or an intensity of the position signal.

18. The system of claim 15, further comprising:
a second wireless device configured to be arranged at a second position along the informational tour and emit a second position signal; and
the electronic device configured to detect the second position signal and output information based upon the detected second position signal.

19. The system of claim 15, further comprising a computing device configured to receive the position signal from the electronic device and send the information based upon the position signal to the electronic device.

20. The system of claim 15, wherein:
the wireless device is configured to emit only the position signal from the wireless device; and
the position signal comprises only an identifier unique to the wireless device.
